(19) United States
(12) Patent Application Publication
(10) Pub. No.: US 2008/0012289 A1
(43) Pub. Date: Jan. 17, 2008

(54) Mechanical repair fitting for polyethylene pipes

(75) Inventor: Gregory H. Goble, Lake Forest, CA (US)

Correspondence Address: FULWIDER PATTON LLP, 200 OCEANGATE, SUITE 1550, LONG BEACH, CA, 90802, US

(73) Assignee: R.W. Lyall & Company, Inc.

(21) Appl. No.: 11/232,520

(22) Filed: Sep. 22, 2005

(51) Int. Cl. F16L 55/18

(52) U.S. Cl. 285/15

(57) ABSTRACT

A mechanical repair fitting for arresting propagation of a damaged section of flexible pipe such as polyethylene pipe is disclosed wherein mating cylindrical half-pipe sections are hingedly coupled together so as to flex open for receiving said damaged pipe. The fitting is then locked onto the pipe section thereby compressing two annular seals to form a pressurized compartment between the fitting and the pipe. A valve forms a port to the pressurized compartment and permits the control of pressure therein. If the pipe is breached, the compartment will have the same pressure as the pipe during fluid flow such that strain due to a pressure differential is alleviated. If there is no breach but damage, the pressure can be equalized with the internal pressure to prevent propagation of the damage.

### FIELD OF THE INVENTION

This invention relates generally to the general field of repair of fluid conveying conduits, and more particularly to a mechanical repair fitting for the permanent repair of damaged or punctured polyethylene pipe.

### BACKGROUND OF THE INVENTION

In many areas in the United States and around the world, the ground at some point during the winter season may reach temperatures below freezing. Metal pipes are used to convey water and other fluids to and away from homes and businesses may crack or rupture when the temperature gets below freezing. For this reason, the use of polyethylene (PE) pipe is a favorable alternative. PE plastic pipes are more resistant to rupture in the event of freezing temperatures. Polyethylene is particularly suitable for underground piping because it has excellent corrosion and crush resistance, as well as high impact strength and flexibility. The plastic pipe is suitable for temperatures from minus 65° to 120° F. in low pressure applications, and to 200° F. in non-pressure applications.

Polyethylene pipe is commonly used in various low pressure water systems such as sprinkler systems, household water needs and the like. It also is used in industrial and chemical laboratory drainage systems and for underground gas piping. PE is also used to transport gas under ground, such as natural gas.

When a small area of a PE pipe becomes damaged, it may be possible to place a live tap service tee over the damaged area. In this case, the damaged area must be smaller than the area of the tapping tee cutter so that the entire damaged area is removed by the coupon cutter. This allows very small area damages to be repaired under a non-blowing gas condition. Should a larger portion of a PE pipe become damaged with significant pipe wall loss, it is frequently necessary to excavate the buried pipe and cut-out and replace the damaged section with a new section of pipe. In a case where the pipe is punctured, cracked, or otherwise breached, the damaged area would need to be isolated by line stopping or pipe squeezing equipment to stop the flow to the damaged area before a repair could be made. In such cases, typically multiple excavations are necessary in order to isolate the damaged area and it may be necessary to build a bypass around the damaged area of the pipe before isolating the pipe to allow for continued flow in the system. After a bypass conduit is installed, flow in the pipe is discontinued in the damaged section so that the breach may be removed. To join a new section of pipe, several methods can be employed. Mechanical couplers, electro fusion fittings and heat fusion joining are some of the methods available. In order to build a bypass and isolate the damaged portion of the pipe, as many as three excavations are necessary. In addition, in the case of heat fusion joining and electro fusion fittings, a cool down period is necessary before the new section of pipe can be put into service. All of this is accomplished with considerable time, expense, and effort.

Other systems in the prior art for repairing a flexible pipe, have proved to be less than completely satisfactory. Atsumi, et al., U.S. Pat. No. 6,161,878 describes an external cover type including a plurality of split pipe members divided in the peripheral direction of the pipe that cooperate to compress an elastomer seal in association with the fastening operation. The object of the Atsumi, et al. device is to maintain a circular profile in the pipe section under the influence of external forces such as earthquakes, differential settlement and the like, to prevent leaking around the elastic seal. That is, if the pipe is allowed to deform into an oval shape, the seal may not be uniformly pressed against the pipe causing leakage. The radial deformation limiting feature of the Atsumi, et al. patent is characterized by split-type members that contact the fluid transport pipe at locations on either side of the seal. While the Atsumi, et al. device provides a structural enhancement to the fluid conducting conduit, it can not equalize the pressure in the fitting and would best be ineffective to attenuate further damage to a pipe having a crack, gauge or other damage.

U.S. Pat. No. 4,664,428 to Bridges discloses a sealing plate for sealing the axial joint or joints of a cylindrical coupling. Bridges provides a pipe joint for joining a pair of adjacent pipe ends, comprising a cylindrical coupling member including an axial slit, a pair of annular gasket members shaped to be fitted over the pipe ends and compressed by the coupling member, a sealing plate spanning the axial slit of the coupling member and containing both of the annular gasket members, and means for sealing the gasket. However, Bridges includes no structure for regulating or equalizing the pressure inside the sealing mechanism.

Munday, U.S. Pat. No. 4,653,782 discloses an overlapping pipe repair clamp configuration where halves of a pipe repair clamp form a two-piece collar. The pieces are shaped to form scarf type joints and are provided with portions of a gasket for sealing the surface of the pipe to be repaired from the external surface of the collar. The two pieces of the Munday apparatus are so shaped that at the joints, the internal surface of one piece overlaps the external surface of the other piece with a gasket arranged therebetween. Another pipe repair system is disclosed in U.S. Pat. No. 3,861,422 to Christie. Christie teaches a split-sleeve pipe coupling for sealing a leak, hot tapping a pipe, and electrically insulating a section of pipe. The Christie apparatus includes a threaded boss defining access to the interior, where the boss is purportedly for inserting a cutting tool to connect to the pipe and also for connecting a valve or other suitable equipment. U.S. Pat. No. 6,237,640 to Vanderlee discloses a pipe repair fitting with electrical wires embedded in a three part fitting that can be used to fuse portions of the pipe together and thereby seal the pipe. Each of the forgoing prior art systems have shortcomings which limits its usefulness for the present application.

### SUMMARY OF THE INVENTION

The present invention seeks a solution for permanently repairing a damaged (gauged or ruptured) polyethylene pipe by sealing a fitting around the damaged section of the pipe, where the fitting replaces the pipe as the pressure carrying member. In equalizing the pressure on the inside and outside of the damaged pipe section, the forces that cause the damage to propagate is alleviated and the growth of the defect along the pipe surface is attenuated. A multi-component hinged fitting is placed around the pipe where it is pressed together, compressing circumferential seals at respective outer ends of the fitting against the pipe's outside diameter to effectuate a seal within the fitting. An annular space is created between the inside surface of the fitting and the pipe's outer diameter along a distance between two circumferential seals. In the case of a gauged pipe that is not ruptured, the annular space could be maintained at the pipe's internal pressure to equalize the pressure across the damaged area. If the pipe is breached, the annular space can be evacuated through a valve during installation that once sealed will equalize the pressure across the breach and reduce the propensity for further propagation of the damage. With the fitting in place, the seals prevent further leakage while the pressure in the annular space is chosen to minimize further damage, and the pipe is thus repaired in place without further excavation.

A benefit of the present invention is that a permanent repair of a breach type is accomplished without the necessity to stop the flow of gas or other fluid from the damaged section before installation. A single, or plurality of self-sealing purged ports are integrated into either or both parts of the fitting that allow for relieving of pressure in the fitting to atmospheric pressure during the installation process. Further, the semi-cylindrical halves of the fitting are connected by a sliding hinge that allows the fitting to be positioned and aligned over the damaged portion of the pipe during installation. Further, the mating halves of the mechanical fitting are preferably equipped with positively locking detents that cooperate with opposed voids in the complementary halve to interlock the assembly over a damaged portion of the pipe, thereby holding the fitting together while permanent hardware is secured. The permanent hardware may comprise a separate mechanical cage or jacket that can be placed over the mating halves of the fitting to reinforce the connection and resist separation of the fitting halves in the event of large pressure fluctuations. The cage includes a separate hinge and locks over the fitting with fasteners that maintain the fitting closure when tightened.

Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is an elevated perspective view of a first preferred embodiment of the fitting of the present invention;

FIG. 2 is a front view, partially in cross section of the fitting of FIG. 1;

FIG. 3 is a cross sectional view of the fitting of FIG. 1 taken along lines 2,2;

FIG. 4 is an enlarged sectional view of the locking mechanism of the fitting of FIG. 1; and

FIG. 5 is an elevated perspective view, partially cut away, of the fitting of FIG. 1 engaging a PE pipe.

### DETAILED DESCRIPTION OF THE INVENTION

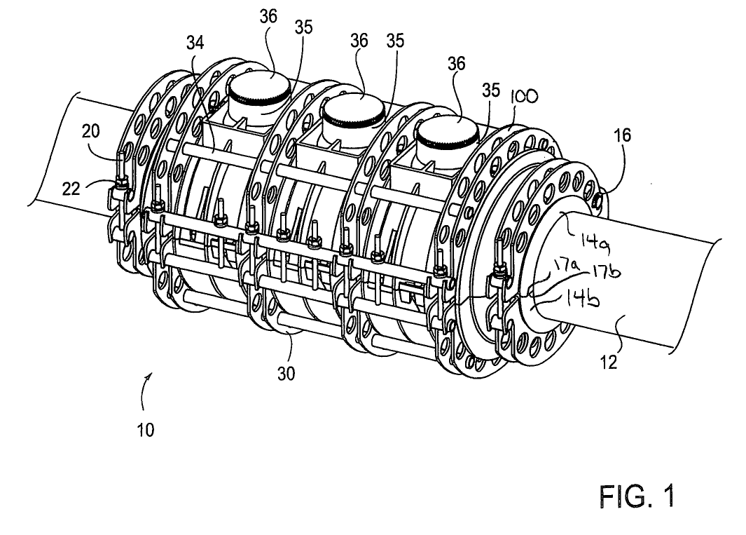

FIG. 1 illustrates a first preferred embodiment of the present invention, wherein a polyethylene pipe 12 is enclosed by a mechanical repair fitting 10 to reduce hoop stress on a damaged section of the pipe and attenuate further damage. The invention resists further damage to the pipe by relieving the forces on the pipe's surface resulting from unequalized pressures inside and outside the damaged section of the pipe. That is, when the pressure differential across the pipe is significant, the resulting forces will cause any crack or defect to propagate until the pipe ruptures or is critically damaged. The repair fitting 10 includes two semicircular halves 14a,b that are coupled along a first longitudinal side by an integral sliding hinge 16, such that free ends 17a,b freely rotate about said hinge 16. The hinge 16 allows the fitting to open as the two halves 14a,b separate and are thusly placed over a damaged section of the PE pipe.

Along mating surfaces 21,23 of the free ends 17a,b at longitudinally spaced intervals are complimentary elements of a plurality of snap clips 99 to prevent the fitting halves from separating while the permanent hardware is secured. The snap clip 99 (see FIG. 4) comprises a resilient elongate detent member 18 with a barbed end 18a that is received in a void 25 on the mating surface. The void 25 includes a receptacle with a shoulder portion that is positioned to engage the barbed end 18a of the detent and retain the detent therein. As the two mating halves 14a,b are closed about the damaged section of pipe, the snap clips 99 align and fix the fitting on the pipe and prevent the fitting from inadvertently opening during the installation process, freeing the installer to focus on permanently locking the fitting with threaded fasteners.

With the snap clips in place, a mechanical jacket or cage is placed over the fitting to permanently secure the fitting in a closed relationship. The cage 100 is formed by a series of brackets 30 having a U-shaped profile having a separate hinge that allows the brackets to close onto the fitting 10. The brackets 30 connect to the fittings via a keeper 105 on the fitting that projects through an opening on the bracket 30 to maintain the bracket on the fitting. Each bracket 30 on the cage is equipped with tangentially disposed threaded members 20 secured with respective fasteners 22 to lock the cage 100 onto the fitting.

The U-shaped brackets preferably include longitudinally aligned holes 31 colinear with neighboring holes on adjacent brackets 30 so as to receive a retaining rod 34 thereinthrough to reinforce the threaded fasteners 20 and prevent the fitting 10 from opening at a sectional break. Additional holes 32 in the brackets 30 can be used to reduce weight in the cage 100. After the retaining rod 34 is placed through the aligned holes 31 to fix the fitting in place, the fasteners 22 on the respective threaded member 20 can be systematically tightened to ensure a uniform seal along the longitudinal edge between mating surfaces 17a,b.

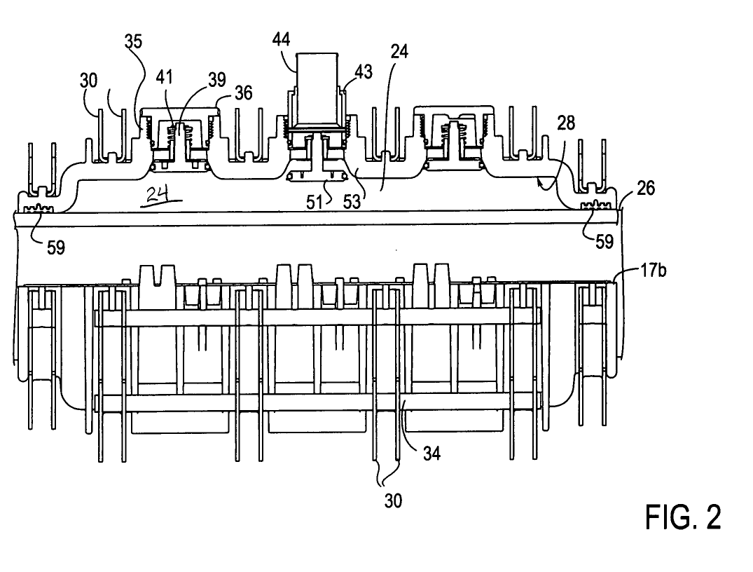

The fitting creates an annular space 24 between the outer surface 26 of the pipe 12 and the inner surface 28 of the fitting 10 (as shown in FIG. 2). The fitting includes three valve ports 35 with respective covers 36. The valve ports 35 are used to control the pressure in the annular space 24 during installation and can establish the desired pressure after installation to equalize the forces on the pipe. As shown in FIG. 2, each valve port 35 includes a mechanical seal 51 that may be spring biased using a spring 41 to self-seal the port 35 using the internal pressure within the annular space 24 between the pipe and the fitting. The pressure in the seal 51 can be relieved during installation using a tool 44 with a threaded coupling 43 that when rotated in the port 35 displaces the mechanical seal 41 as shown in FIG. 2. In addition, the valve port 35 may be accessed once the fitting is locked onto the pipe to balance the pressure inside and outside the pipe at the damaged area, thereby alleviating any residue strain energy and attenuating further propagation of cracks or other damage.

FIG. 2 shows a partial cross section of the respective valve ports 35 including an exposed valve port connected to a tool 44 for relieving the pressure inside the fitting's annular space 24. Threading the tool 44 into the valve port 35 pushes a sealing 51 out of contact with the neck 53 of the valve stem to expose the internal pressure of the fitting to the connected pipe. In this manner, the pressure inside the fitting 10 can be controlled through the pipe 44 to either pressurize the fitting or to alleviate a high pressure therein.

The pressure within the annular space 24 between the repair fitting 10 and the PE pipe 12 is maintained by compression of elastomer seals 59 at the respective ends of the fitting. The compression of the seals 59 between the fitting 10 and the pipe 12 prevent fluid or gas from escaping, such that the annular space becomes a self-contained pressure system that may be controlled to match the pipe's own pressure. Therefore, if a portion of the pipe has been damaged but not completely breached, the external pressure on the pipe (i.e., the pressure within the annular space of the mechanical fitting) can be equalized with the internal pressure of the pipe to alleviate any pressure differential across the pipe's cross section. In this manner, unwanted strain in the damaged section of the pipe can be controlled and further propagation of the damage can be arrested. If the pipe has been breached, a non-pressure bearing fix or patch can be implemented and then the repair fitting placed over the patched portion of the pipe and the pipe can be replaced in service without diverting the flow of fluid through the pipe. Alternatively, the repair fitting can be placed directly over the damaged section of the pipe such that the annular space will fill the conveying fluid and equalize the pressure both inside and outside the pipe within the confines of the mechanical repair fitting. In either case, further damage due to propagation of a crack or gauge can be limited by the pressure equalizing feature of the present invention.

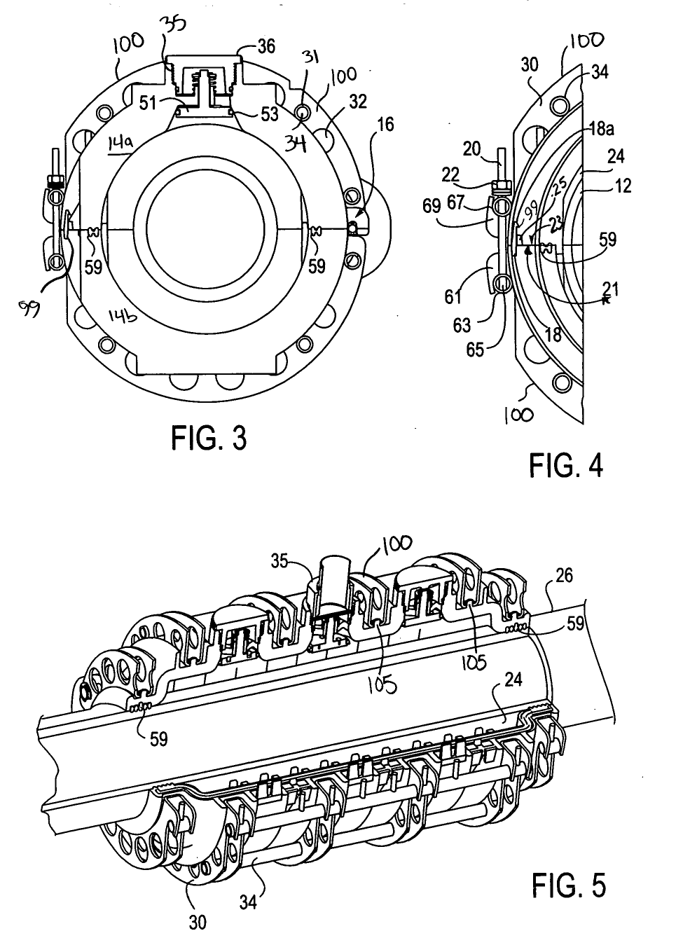

FIGS. 3 and 4 illustrate the relation of the sliding hinge 16, the valve ports 35, and the seals 59 along diametrically opposed faces of the mating halves 14a,b. The locking mechanism on the cage 100 that is placed over the fitting 10 features an inverted U-shaped catch 61 on a first half 14b that traps a cylindrical anchor 63 longitudinally disposed on the distal end 65 of the threaded member 20, which cooperates with a similarly disposed cylindrical member 67 secured within a U-shaped catch 69, where said threaded member 20 passes through said cylindrical member 67. When the fastener 22 is tightened onto the threaded member, the cylindrical member 67 within catch 69 and cylindrical anchor 63 within catch 61 are drawn together, forcing the cage 100 closed tight about the fitting. As the fasteners 22 are further tightened on the threaded members 20, the cooperation of the hinged cage halves further compresses fittings' elastomer seal 59 against the exterior surface of the PE pipe 12.

FIG. 5 shows the cooperation of the respective ends of the fitting 10 and the compression of the elastomer seals 59 against the external surface 26 of the PE pipe. As can be seen, a gap between the external surface of the pipe and the internal surface of the repair fitting forms the annular space 24 that can be used and controlled to adjust the pressure. The valve port 35 provides access to this annular space, that can be either pressurized or depressurized as necessary to equalize the pressure across the damaged pipe surface.

In practice, when a determination is made that a portion of a polyethylene pipe 12 needs to be repaired, the excavation is performed to locate the damaged area. A repair fitting 10 must be selected that is long enough to place the elastomer seals at two locations that will isolate and surround the damaged area of the pipe. The integral sliding hinge 16 on the repair fitting 10 actuates to allow the fitting halves 14a,b to be aligned and closed around the damaged area, and then the integrated positive lock snap clips are engaged as the mating halves are brought into contact with each other to prevent the fitting halves from separating while the hardware is secured. With the lock snap clips engaged, a mechanical cage or jacket 100 is placed over the fitting 10 and fasteners 22 on the cage are tightened on the vertically extending threaded members 20 thereby locking the mechanical cage on the fitting. The tightening of the threaded members on the cage compress the elastomer seals disposed on mating surfaces of the fitting against the outer surface of the pipe forming an annular space with a controllable pressure. Retaining rods aligned longitudinally in holes in the cage's radially projecting U-shaped brackets reinforce and align the mating halves in the presence of pressures that may cause the fitting to warp or breach.

During the installation of the fitting, the valve port cap is removed and a tool is inserted into the valve port to access the pressurized annular space within the fitting. The tool can be used to relieve elevated pressure in the fitting due to the escape of flowing gas, or alternatively coupled to a pressure regulator to ensure the pressure in the annular space coincides with the internal pressure within the pipe. With the pipe's internal and external pressures within the fitting equalized, the tool is removed and the valve port self-seals to complete the repair. The fitting thus becomes a permanent part of the new pipe system and is buried in place to complete the process.

The present invention may be embodied in other specific forms without departing from the spirit or central characteristics thereof. The present embodiments are therefore to be considered in all respect as illustrative and not restrictive, the scope of the invention being indicated by the appended claims rather that the forgoing description and all changes which come within the meaning and range of equivalency of the claims are therefore intended to be embraced therein.

1. A mechanical repair fitting for a pressure carrying pipe comprising:
first and second mating halves cooperating to form a cylindrical fitting adapted to overlay said pressure carrying pipe, each said portion including an inner surface and an outer surface;
a hinge coupling the first and second mating portions at first respective longitudinal edges;
a first locking mechanism for retaining said first and second mating halves in proximity with each other as said halves are brought together;
a mechanical cage overlaying said first and second mating halves, and comprising a second locking mechanism for compressing said first and second mating portions at second respective longitudinal edges to define an annular space between said inner surfaces of said first and second portions and said pressure carrying pipe;
first and second annular elastomer seals compressed between said pressure carrying pipe and said inner surfaces of said first and second mating portions to maintain pressure in said annular space; and
a pressure port on said first mating portion for adjusting a pressure within the annular space to reduce a pressure differential between said pipe's internal pressure and said pressure within said annular space.

2. The mechanical repair fitting of claim 1 wherein said second locking mechanism comprises oppositely facing U-shaped catches mounted on said respective longitudinal edges of said mechanical cage, first and second cylindrical members disposed within said U-shaped catches, and means for releasably shortening the distance between said cylindrical members to close the mechanical cage.

3. The mechanical repair fitting of claim 1 wherein said mechanical cage further comprises a plurality of axially spaced, radially extending U-shaped brackets, said U-shaped brackets further comprising longitudinally aligned holes for receiving a retaining rod therein.

4. The mechanical repair fitting of claim 1 wherein said first self-locking mechanism comprises an elongated detent member with a barbed end projecting from one of said mating halves, said elongated detent member resiliently engaging a shoulder portion of a cooperating void to secure said detent member therein.

5. A method for repairing a damaged section of a fluid conducting pipe comprising:
separating hingedly connected first and second half-cylindrical mating portions of a repair fitting and placing said first and second half-cylinder mating portions about said damaged section;
providing first and second elastomer annular seals at respective ends of said repair fitting, and positioning said repair fitting such that said first and second elastomer seals straddle said damaged section;
closing said hingedly connected first and second half-cylinder mating portions about said fluid conducting pipe, thereby compressing said elastomer seals between said pipe and said mating portions to form a pressure tight seal in an annular spaced defined between said seals;
providing a pressure valve in fluid communication with said annular space; and
pressurizing said annular space such that a pressure differential between said pressure in said fluid conducting pipe and said annular space pressure is minimized to resist propagation of damage in said pipe resulting therefrom.

6. The method for repairing a damaged section of pipe of claim 5 further comprising aligning the hingedly connected first and second half-cylinders using a sliding hinge and then locking the half-cylinders using lock snap clips.

7. The method for repairing a damaged section of pipe of claim 5 wherein the annular space is pressurized to a pressure less than or equal to a pressure in said fluid conducting pipe.

8. The method for repairing a damaged section of pipe of claim 5 further comprising placing a mechanical cage over said fitting, and securing said mechanical cage using a longitudinally aligned retaining rod through a series of axially aligned holes in radially projecting brackets to prevent misalignment of the fitting.

9. The method for repairing a damaged section of pipe of claim 5 wherein the damaged section of pipe is not breached, and the pressure in said annular space is controlled to so that the pressure within the pipe as fluid is flowing is equalized with the pressure in the annular spaced outside of the damaged pipe at the damaged section.
